(19) United States
(12) Patent Application Publication
(10) Pub. No.: US 2009/0060191 A1
(43) Pub. Date: Mar. 5, 2009

(54) INTERFACE CIRCUIT, INFORMATION PROCESSING DEVICE, AND INFORMATION PROCESSING SYSTEM

(76) Inventor: Hiroyuki Yabuno, Osaka (JP)

Correspondence Address: MCDERMOTT WILL & EMERY LLP, 600 13TH STREET, NW, WASHINGTON, DC, 20005-3096, US

(21) Appl. No.: 12/282,054

(22) PCT Filed: Feb. 23, 2007
(86) PCT No.: PCT/JP2007/053386

§ 371 Date: Sep. 8, 2008

(30) Foreign Application Priority Data
Mar. 8, 2006 (JP) 2006-062315
Apr. 7, 2006 (JP) 2006-106479

(51) Int. Cl. H04L 9/20; G06F 12/02

(52) U.S. Cl. 380/268; 711/202; 711/E12.002

(57) ABSTRACT

A scrambling circuit 104 for encrypting command information is provided in a sending side host computer 3001, and a descrambling circuit 101 for decoding the encrypted command information is provided in a receiving side information processing overall circuit 3003. A converter circuit 102 is provided in an interface circuit 103. For storing sequentially transmitted command information into a memory module 3004, the converter circuit 102 address-converts them so that the received command information is not stored at addresses in a reception sequence. Hence, the to-be-concealed content of information in the command is prevented from leaking caused by observation of an information storage portion in the circuit from outside or by communication intercept between devices.

### TECHNICAL FIELD

The present invention relates to a technology for information communication between information processing devices, and particularly relates to a technology for an interface between digital devices typified by an ATAPI (AT Attachment Pachet Interface), an SCSI (Small Computer System Interface), and the like.

### BACKGROUND ART

In conventional information processing devices using an interface circuit, such as an ATAPI circuit, some of which include a device for scramble communication in data transmission (for example, a copy protection technique CSS in DVD drive appliances; see Non-patent Document 1), command information (command packets) is transmitted through cables without especially processing data thereof (see Non-patent Document 2, for example).

Configurations of a conventional interface circuit and an information processing device using it will be described with reference to the drawings. FIG. 15 is a block diagram showing one example of a conventional information processing device and an information processing system. In FIG. 15, reference numeral 3001 denotes a host computer, 3002 denotes an information processing device, 3003 denotes an information processing overall circuit, 3004 denotes a memory module, 3005 denotes an information processing circuit. Further, S3000 denotes an interface signal, S3001 denotes an interface internal signal, S3002 denotes a memory write date signal, S3003 denotes a memory read data signal, and S3004 denotes a memory control signal.

Note herein that the terms, a “memory” and a “memory module” in this description means not only a memory having a physical package, such as a general-purpose SRAM but also various storage means capable of accessing data at an address, such as a flip-flop circuit.

In the conventional information processing system, the host computer 3001 is connected to the information processing device 3002 through the interface signal S3000, thereby attaining transmission of commands and data.

First, command information is issued from the host computer 3001 and is transmitted to the information processing device 3002 through the interface signal S3000. In general, the command information composed of a plurality of bytes or words is transmitted, without being processed, to the memory module 3004 through the interface internal signal S3001 and the memory write data signal S3002 in this order. The command information is sequentially written at addresses in the memory module 3004 specified by the memory control signal S3004 as a control signal from the information processing circuit 3005 at timings specified by the memory control signal S3004.

Next, the information processing circuit 3005 controls the memory control signal S3004 to read the command information from the memory module 3004 and takes the command information through the memory read data signal S3003. Then, the information processing circuit 3005 interprets the thus taken command information and executes command processing indicated therein.

When data transmission is determined to be necessary in executing the command processing by the information processing circuit 3005, the data transmission is executed between the host computer 3001 and the information processing device 3002. In a case of data transmission in the direction that the data is taken from the host computer 3001 to the information processing device 3002, information transmission is executed basically in the same manner as the command information transmission. In reverse, in a case of data transmission in the direction that the data is taken from the information processing device 3002 to the host computer 3001, data to be sent to the host computer 3001 from the information processing circuit 3005 is transmitted through the memory write data signal S3002 to be written into the memory module 3004, and the data is read out sequentially from the memory module 3004 upon preparation of the host computer 3001 or upon request from the host computer 3001 and is transmitted through the interface signal S3000, through the memory read data signal S3003, and the interface internal signal S3001, thereby reaching the host computer 3001. The write paths from the information processing circuit 3005 to the memory module 3004, which are needless to be described in detail in the present description, are present actually, though not shown.

A configuration and an operation of a memory module in an interface circuit will be described next with reference to FIG. 16. FIG. 16 is a block diagram showing one example of a memory in an interface circuit. In FIG. 16, reference numeral 3004 denotes a memory module, 3102 denotes a decoder circuit, 3103 denotes an access unit data storage cell group for storing data per word unit composed of a predetermined number of bits, and 3104 denotes a selector circuit. Further, S3101 denotes a write enable signal, S3102 denotes a memory write address signal, S3103 denotes a memory read address signal, S3002 denotes a memory write data signal, S3003 denotes a memory read data signal, and S3004 denotes a memory control signal.

The access unit data storage cell group 3103 is composed of storage cells cell[0], cell[1], . . . cell[MS−1]. Wherein, MS is the number of storage cells in the memory module. In the present description, the term, the “storage cell” does not mean storage means having a special configuration but means mere means for storage. Namely, the storage cell may be a storage cell in an SRAM architecture or in a DRAM architecture or a digital logic circuit including a flip-flop circuit as a main component.

A data write operation of the memory module 3004 will be described first. In a state in which a write address is specified by the memory write address signal S3102 while write data is specified by the memory write data signal S3002, when the write enable signal S3101 is asserted one or more clocks, the specified data is written at the specified address.

Next, a data read operation of the memory module 3004 will be described. When an address at which data is to be read out is specified by the memory read address signal S3103, the read data is output through the memory read data signal S3003.

Herein, description is given on the assumption that a clock not shown is given to the memory module 3004. The memory module is assumed to be synchronous type memory in the explanation of the prior art and the description of the embodiments of the present invention in the present description. However, whether the module is of synchronous type or asynchronous type presents no essential difference, and the use of asynchronous type memory necessitates slight change in signal usage. It is therefore needless to say that a skilled person can readily carry out replacement thereof.

The memory module 3004 is of multi-port type capable of simultaneous writing and reading. In the present description, description will be given of an operation of a multi-port type memory module. Wherein, this means that the memory module herein is a memory module merely capable of writing and reading with neither arbitration control nor a temporary buffer necessitated, and it is obvious to a skilled person that addition of an arbitration circuit or a temporary buffer enables a single-port type memory modules to be used as if to the multi-port type memory module.

A write operation to a memory module in the conventional interface circuit upon reception of command information will be described with reference to FIG. 17 and FIG. 15 which has been already referred to. FIG. 17 is a diagram showing one example of a write operation to the memory in the conventional interface circuit. In FIG. 17, reference numeral 3004 denotes a memory module, 3201 denotes first received data, 3202 denotes second received data, 3203 denotes third received data, and 3204 denotes fourth received data. Further, S3002 denotes a memory write data signal, S3003 denotes a memory read data signal, S3101 denotes a write enable signal, S3102 denotes a memory write address signal, and S3103 denotes a memory read address signal.

First of all, the information processing circuit 3005 in FIG. 15 prepares to receive command information by initializing the write address value to 0. Namely, when the first received data 3201 is provided to the memory write data signal S3002, the signal value 0 is provided to the memory write address signal S3102 in parallel. At this timing, the write enable signal S3101 is asserted one or more clocks, so that the first received data 3201 as first data of the command information is written at the address 0 in the memory module 3004. Next, the information processing circuit 3005 increments the write address to provide the signal value 1 to the memory write address signal S3102. Similarly to the previous operation, the second received data 3202 is then written at the address 1 in the memory module 3004. Subsequently thereto, the same operation is done successively, namely, the received data are successively, in other words, sequentially written into the memory module 3004. In this way, the command information is stored into the memory module 3004.

Non-patent Document 1: “DVD copy write protection system,” National Technical Report, Vol. 43, No. 3, June 1997, pages 118 to 122

Non-patent Document 2: “Extensive Study on ATA(IDE)/ATAPI,” published by CQ Publishing Co., Ltd., ISBN4-7898-3321-6

### DISCLOSURE OF THE INVENTION

### Problems that the Invention is to Solve

In communication between information processing devices using the conventional interface circuit described so far, the content of a command transmitted between the devices can be confirmed by observing a signal line of a cable from outside. Further, a device for such observation of communication between devices are commercially available as a bus analyzer. Accordingly, in the case where information to be concealed is present in a command or a command sequence, a person with bad faith may intercept communication between the devices to acquire the information.

Further, in the case where non-scrambled or descrambled transmission data information and command information in a command packet are stored directly in a memory of the interface circuit, there involves a risk that the content of the information may be analyzed by proving an information storage portion in the interface circuit from outside. Even if the interface circuit is implemented as a part of an internal circuit of an LSI, the use of an LSI analyzing device enables analysis of the internal signal of the LSI, which involves a problem in information concealment.

### Means for Solving the Problems

The present invention has its objects of allowing an interface circuit to have a function of decoding, in the case where command information in communication information is encrypted for preventing the command information from being analyzed even upon interception of communication between devices, the encrypted command information and of providing an information processing system that performs communication of encrypted command information between devices.

Another object of the present invention is to inhibit analysis of the content of stored data information and stored command information even if an information storage portion in an interface circuit is proved from outside for analyzing the content of the information, thereby enhancing confidentiality of the information.

To attain the above objects, in the present invention, command information is encrypted for communication and decodes the thus encrypted command information by descrambling means provided in an interface circuit.

Further, in the present invention, each information unit composing data information or command information is stored into storage means at an address other than that in the reception sequence.

Specifically, an interface circuit in accordance with the present invention includes: storage means; and conversion means which sequentially receives a plurality of successive serial information units, which compose command information or data information, and generates storage addresses to the storage means by address conversion which makes all or a part of the information units of at least one of the command information and the data information to be in a sequence at least other than a reception sequence, wherein each of the information units of the command information or the data information as a target of the address conversion is written into the storage means at a corresponding storage address address-converted by the conversion means.

In the interface circuit of the present invention, the conversion means performs the address conversion with the address conversion defined as conversion F for converting a sequential sequence to a random sequence, the conversion F satisfying both of:.

F[j+1]≠F[j]+1; and

F[j+1]≠F[j]−1,

where the conversion F is a function for converting an address j (j is an arbitrary integer satisfying 0≦j<K where K is an arbitrary integer) of a conversion origination to an address F[j] of a conversion destination.

In the interface circuit of the present invention, the command information or the data information to be address-converted is encrypted, and the interface circuit further comprising descrambling means for decoding the encrypted command information or data information before storage to the storage means.

In the interface circuit of the present invention, the conversion means generates the storage address so that even when address values generated by replacing two or more bits of each storage address after the address conversion is regarded as second address values, all or a part of the information units of the command information or the data information as a target of the address conversion is in a sequence other than the reception sequence.

In the interface circuit of the present invention, in obtaining different addresses F(i)[j] of different conversion destinations by repeating i times (i is an integer) replacement of predetermined two or more component bits of an address F[j] of a conversion destination after the conversion F under a predetermined rule, the conversion means performs the address conversion with the address conversion defined as the conversion F, the conversion F satisfying both of:

F(i)[j+1]≠f(i)[j]+1; and

F(i)[j+1]≠F(i)[j]−1,

where an arbitrary integer pair of {i, j} satisfies 0≦i<L and 0≦j<K (i is an arbitrary integer satisfying 0≦i<K).

In the interface circuit of the present invention, the storage means includes a plurality of sub storage means, and each information unit of the command information data or the data information as a target of the address conversion is divided and stored into the plurality of sub storage means separately.

In the interface circuit of the present invention, in storing each of the plurality of divided information units into the plurality of sub storage means separately, the conversion means generates storage addresses different from each other for plural pieces of divided information of each of a part or all of the plurality of information units.

In the interface circuit of the present invention, the conversion means performs the address conversion with the access conversion defined as the conversion F and conversion G for converting a sequential sequence to a random sequence, the conversion F and the conversion G satisfying both of:

F[j+1]≠F[j]+1; and

F[j+1]≠F[j]−1, and

both of:

G[j+1]≠G[j]+1; and

G[j+1]≠G[j]−1, respectively,

where the conversion F and the conversion G are functions for converting an address j (j is an arbitrary integer satisfying 0≦j<K where K is an arbitrary integer) of an address origination to addresses F[j] and G[j] of conversion destinations, respectively, and the conversion F and the conversion G satisfying:

F(h)[j]≠G(i)[j]

where an arbitrary integer set of {h, i, j} satisfies 0≦h<L, 0≦i<L, and 0≦j<K (h is an arbitrary integer).

The interface circuit of the present invention further includes: delay means for delaying the plural pieces of divided information for a predetermined time period so that timings at which the plural pieces of divided information are stored into the plurality of sub storage means are different from each other in storing the plural pieces of divided information into the plurality of sub storage means.

In the interface circuit of the present invention, each of the information units is data of one word composed of eight bits or 16 bits.

In the interface circuit of the present invention, the command information or the data information is transmitted or received between a plurality of information processing devices through a transmission path intervening between the plurality of information processing devices.

In the interface circuit of the present invention, the transmission path is an ATA/IDE bus or an SCSI bus.

An interface processing device of the present invention includes: the above interface circuit; and an information processing circuit for controlling the interface circuit.

An interface processing device of the present invention includes: the above interface circuit; and an information processing circuit for controlling the interface circuit, the information processing circuit allowing the descrambling means included in the interface circuit to decode the command information only upon reception of a vender unique command.

In the interface processing device of the present invention, the information processing circuit controls the interface circuit and controls recording or replying of data from an information recording medium.

An information processing system of the present invention includes: the above information processing device; and a second information processing device communicating with the information processing device.

In the information processing system of the present invention, the second information processing device includes scrambling means for encrypting the command information to be transmitted.

In the information processing system of the present invention, the second information processing device transmits a vender unique command to the above information processing device and transmits, after transmission of the vender unique command, the command information encrypted by the scrambling means to the above information processing device.

In the information processing system of the present invention, the second information processing device is a host computer.

In the information processing system of the present invention, the second information processing device is a host computer, and the scrambling means is a program executed on the host computer.

With the above arrangements, the interface circuit according to the present invention stores each information unit of the data information or the command information into the storage means at an addresses other than that in the reception sequence. Accordingly, even if the information storage portion in the interface circuit is proved from outside, the content of the information stored there cannot be analyzed readily.

Further, the interface circuit according to the present invention divides each information unit composing the data information or the command information and stores the thus divided information into the separate sub-storage means. Accordingly, even if the information storage portion in the interface circuit is proved from outside, analysis of the content of the information stored there becomes further difficult.

### EFFECTS OF THE INVENTION

According to the present invention, even if the information storage portion of the interface circuit is proved from outside, the information content stored therein cannot be analyzed readily, thereby contemplating improvement on confidentiality of non-encrypted or decoded data information and command information.

Further, a single information unit is divided into plural and the thus divided ones are stored in plural storage sites separately in the present invention. Accordingly, the contents of the information stored there are further difficult to be analyzed even if the information storage portion of the interface circuit is proved from outside, thereby remarkably increasing the information confidentiality.

### BRIEF DESCRIPTION OF THE DRAWINGS

FIG. 1 is a block diagram showing one example of an information processing device and an information processing system in accordance with Embodiment 1 of the present invention.

FIG. 2 is a block diagram showing one example of an information processing device and an information processing system in accordance with Embodiment 2 of the present invention.

FIG. 3 is a block diagram showing another example of an information processing device and an information processing system in accordance with Embodiment 2 of the present invention.

FIG. 4 is a block diagram showing one example of a converter circuit in an interface circuit in accordance with Embodiment 3 of the present invention.

FIG. 5 is a diagram showing one example of a write operation to a memory in the interface circuit in accordance with Embodiment 3 of the present invention.

FIG. 6 is a block diagram of an interface circuit in accordance with Embodiment 4 of the present invention.

FIG. 7 is a block diagram showing one example of a converter circuit in the interface circuit in accordance with Embodiment 4 of the present invention.

FIG. 8 is a block diagram showing one example of a configuration of a converter circuit of conversion F in the converter circuit of the interface circuit in accordance with Embodiment 4 of the present invention.

FIG. 9 is a block diagram showing one example of a configuration of a converter circuit of conversion G in the converter circuit of the interface circuit in accordance with Embodiment 4 of the present invention.

FIG. 10 is a drawing showing one example of respective conversion tables for conversion F and conversion G in the converter circuit of the interface circuit in accordance with Embodiment 4 of the present invention.

FIG. 11 is a drawing showing respective conversion tables for conversion F and conversion G in the converter circuit of the interface circuit in accordance with Embodiment 4 of the present invention which list only respective three examples of variations of the first eight elements where bits are replaced in the conversion tables.

FIG. 12 is a drawing showing a table in which numeral values obtained by replacing bits in each numeral value expressed with five bits arbitrarily are generated according to the number of bits of “1” in the numeral values.

FIG. 13 is a diagram showing one example of a write operation to a memory in the interface circuit in accordance with Embodiment 4 of the present invention.

FIG. 14 is a diagram showing one example of a write state in the write operation to the memory in the interface circuit in accordance with Embodiment 4 of the present invention.

FIG. 15 is a block diagram showing one example of a conventional information processing device and a conventional information processing system.

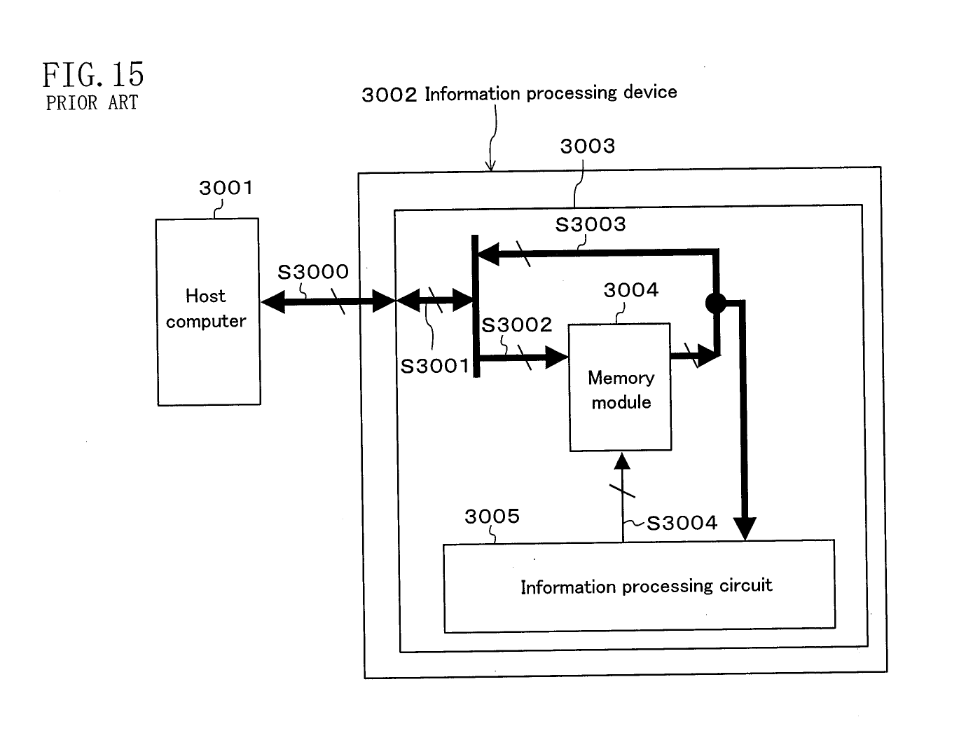

FIG. 16 is a block diagram showing one example of a memory in an interface circuit.

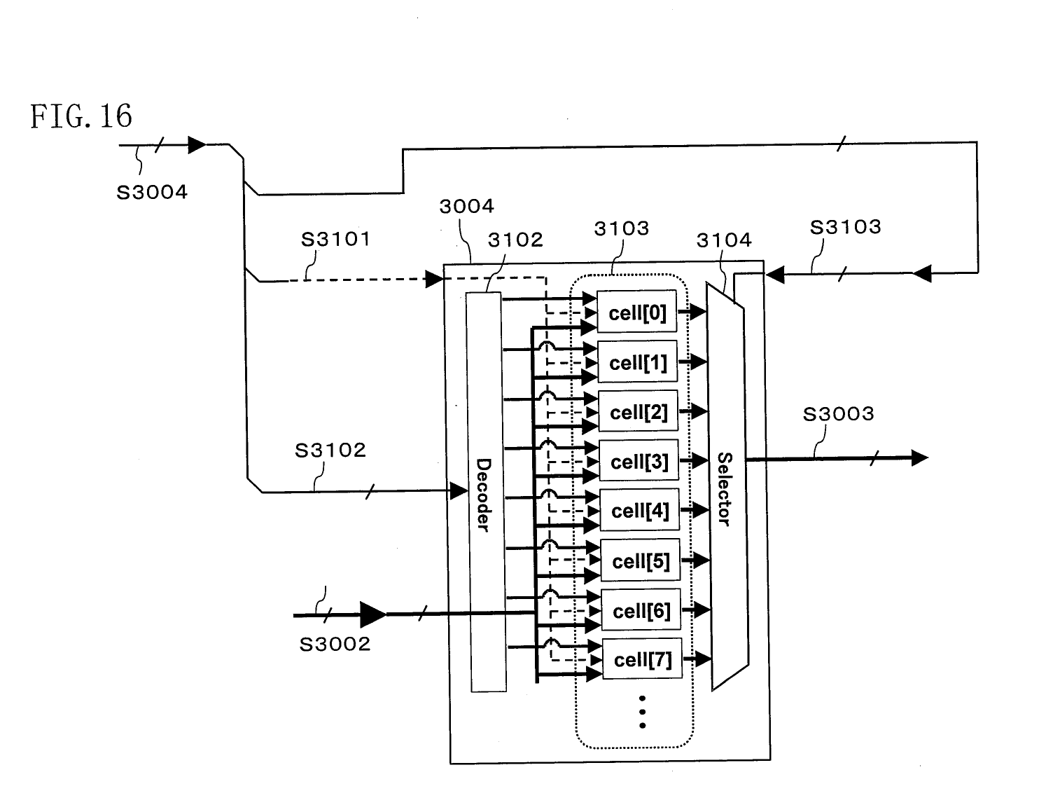

FIG. 17 is a diagram showing one example of a write operation to a memory in a conventional interface circuit.

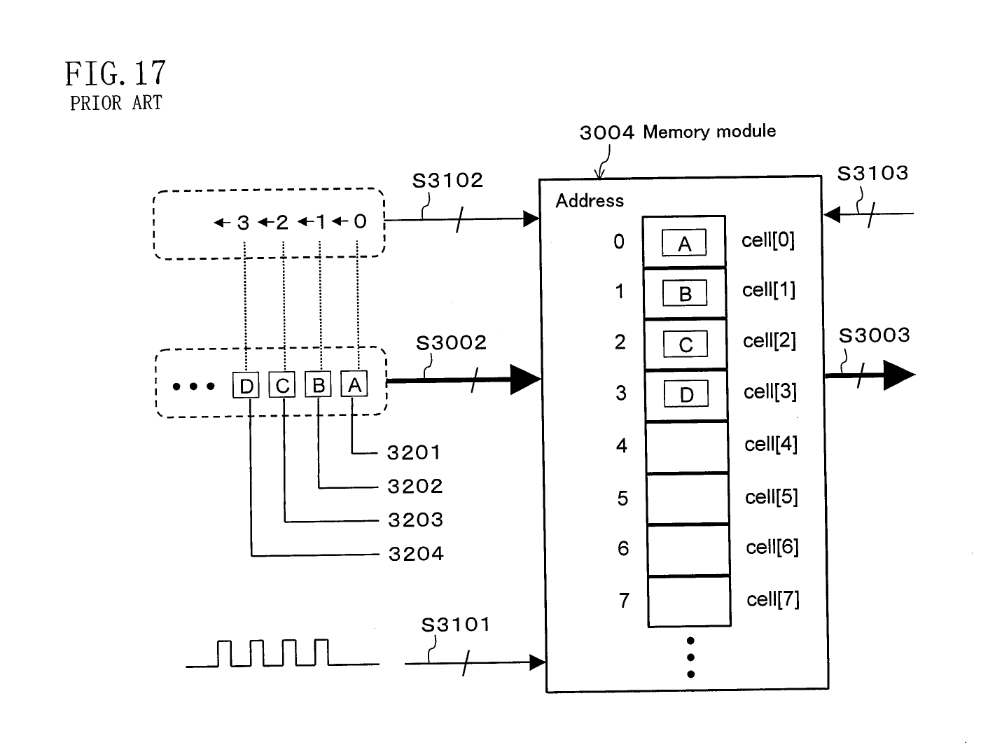

FIG. 18 is a overall configuration diagram in the case where one of two information processing devices connected to a host computer has a vender unique command.

### INDEX OF REFERENCE NUMERALS

101 descrambling circuit (descrambling means) of which targets include command information
102, 1021 converter circuit (converting means)
103, 1031 interface processing circuit
104 scrambling circuit (scrambling means) of which targets include command information
301, 302 memory module (sub storage means)
10211 converter circuit (F)
10212 converter circuit (G)
10213 data signal N-clock delay circuit (delay means)
102111, 1022 first converter circuit of conversion F
102112, 1023 second converter circuit of conversion F
102121 first converter circuit of conversion G
102122 second converter circuit of conversion G
102123 write enable signal N-clock delay circuit
2001 conversion table for conversion F(0)
2002 conversion table for conversion G(0)
2011 conversion destination list corresponding to conversion originations 0 to 7 in conversion F(0)
2012 conversion destination list corresponding to conversion originations 0 to 7 in conversion F(1)
2013 conversion destination list corresponding to conversion originations 0 to 7 in conversion F(2)
2014 conversion destination list corresponding to conversion originations 0 to 7 in conversion G(0)
2015 conversion destination list corresponding to conversion originations 0 to 7 in conversion G(1)
2016 conversion destination list corresponding to conversion originations 0 to 7 in conversion G(2)
2201, 3201 first received data
2202,3202 second received data
2203,3203 third received data
2204,3204 fourth received data
3001 host computer (second information processing device)
3002 information processing device
3003 information processing overall circuit 3004 memory module (storage means)
3005 information processing circuit
3102 decoder circuit
3103 access unit data storage cell group
3104 selector circuit
s100 descrambling circuit control signal
S101, S301 post conversion F memory control signal
S101A, S301A post conversion F write enable signal
S101B, S301B post conversion F memory write address signal
S101C, S301C post conversion F memory read address signal
S302 post conversion G memory control signal
S302A N-clock delay write enable signal
S302B post conversion G memory write address signal
S302C post conversion G memory read address signal
S303 pre N-clock delay memory write data signal
S304 post N-clock delay memory write data signal
S305, S306 memory read data signal
S3000 interface signal
S3001 interface internal signal
S3002 memory write data signal
S3003 memory read data signal
S3004 memory control signal
S3101 write enable signal
S3102 memory write address signal
S3103 memory read address signal

### BEST MODE FOR CARRYING OUT THE INVENTION

### Embodiment 1

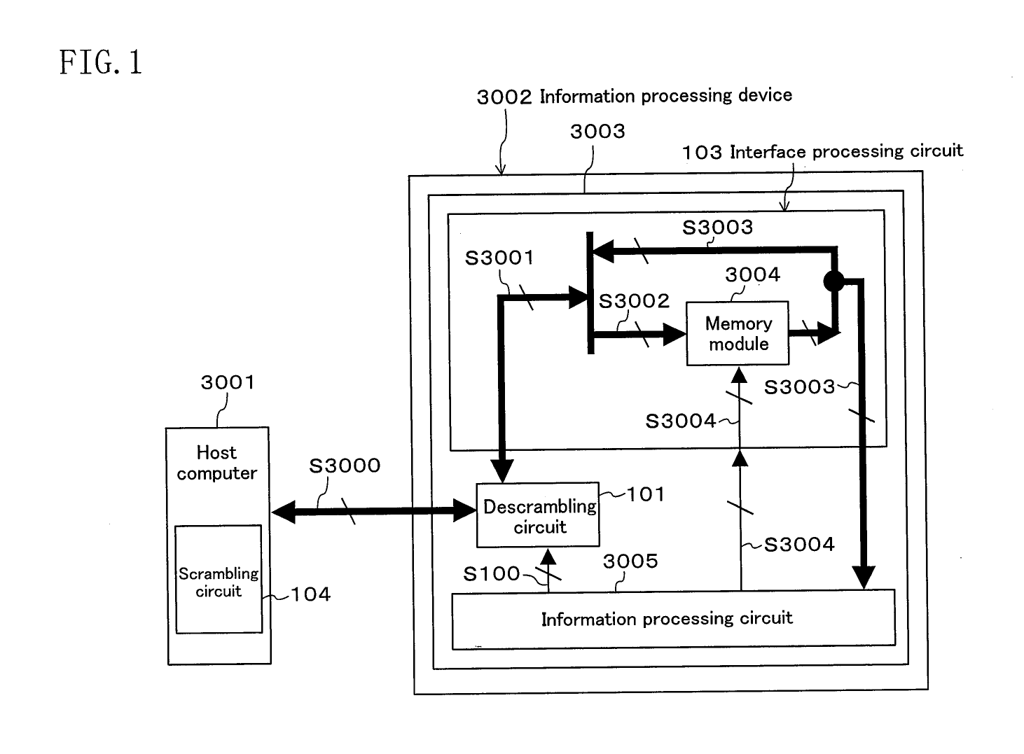

Embodiment 1 of the present invention will be described below with reference to the drawing. FIG. 1 is a block diagram showing one example of an information processing device and an information processing system in accordance with Embodiment 1 of the present invention. In FIG. 1, reference numeral 101 denotes a descrambling circuit (descrambling means) of which targets include command information, 103 denotes an interface processing circuit, 104 denotes a scrambling circuit (scrambling means) of which targets include command information, and 3001 denotes a host computer. The scrambling circuit 104 is a program executed on the host computer 3001. Reference numeral 3002 denotes an information processing device, 3003 denotes an information processing overall circuit, 3004 denotes a memory module (storage means), and 3005 denotes an information processing circuit controlling recording or replaying of data from an optical disk or the like. Further, S100 denotes a descrambling circuit control signal, and S3000 denotes an interface signal. The interface signal S3000 is a signal transmitted through a transmission path of an ATA/IDE bus, an SCSI bus, or the like intervening between the host computer (a second information processing device) 3001 and the information processing device (a first information processing device) 3002 and includes data information and command information. Reference numeral S3001 denotes an interface internal signal, S3002 denotes a memory write data signal, S3003 denotes a memory read data signal, and S3004 denotes a memory control signal.

Scrambling processing and descrambling processing form one pair. The scrambling processing is data processing of encrypting transmitted data on the interface signal S3000 for involving no problem upon leakage. The descrambling processing is processing of recovering encrypted transmitted data to the original data. Concrete methods of the descrambling processing and the descrambling processing include a method in which pseudo random number data is generated to take an exclusive OR, DES encryption, RSA encryption, elliptical curve cryptography, and the like. Various employable schemes are present as the scrambling processing and the descrambling processing, and any method other than those referred to herein may be employed. In addition, other than data processing, mere complicated permutation of a data sequence is employable as the scrambling processing and the descrambling processing. Although there is an encrypting scheme originally including replacement, arbitrary combination of the aforementioned processing and permutation of a data sequences makes data further difficult to be analyzed.

The scrambling means 104 of the host computer 3001 may be implemented by hardware or software. In a case of software implementation, it is preferable to provide a software architecture having tamper resistance so as to be hardly observable from outside.

Some of the conventional interface circuits, information processing devices, and information processing systems scramble only data transmission, but none of them scramble command information. Therefore, insufficient confidentiality is achieved in application fields in which important information is obtainable from command information or a command information sequence.

In the present embodiment, the scrambling processing and the descrambling processing are performed on information including command information to contemplate solving the above problem. When the scrambling processing and the descrambling processing are performed on information including command information for solving this problem, the information processing device cannot be connected to another device including the same physical interface and having been connectable so far. This problem will be described in detail on the assumption of a technique that an optical disc drive is recognized in booting of a host computer to boot the OS from an optical disc (a CD-ROM). In a case of ATA/ATAPI, under the state in which both an information processing device according to the present invention (for example, a CD-ROM drive 1) capable of scrambling command information and an ordinary optical disc drive (for example, a CD-ROM drive 2) incapable of scrambling command information as the conventional one are connected to the host computer, a processing sequence for checking whether the connected device is the ATA device (generally, an DHH is an ATA device) or an ATAPI device (a CD-ROM drive or the like) is performed first to check whether or not it is the ATAPI device. The host computer having recognized that it is the ATAPI device issues a command to the ATAPI device to check the state of the ATAPI. Specifically, the thus issued command is a “TEST UNIT READY” (hereinafter abbreviated it as “TUR”) command or an “INQUIRY” command. In response to the “TUR” or “INQUIRY” command, the ordinary CD-ROM drive 2 incapable of scrambling command information returns correct status information and drive information. In contrast, the CD-ROM drive 1 according to the present invention capable of scrambling command information interpret the “TUR” or “INQUIRY” command as a scrambled command to descramble it, with a result of failure to interpret the “TUR” or “INQUIRY” command, thereby inviting malfunction of the CD-ROM drive 1 of the present invention or the host computer.

In the present embodiment, the CD-ROM drive 1 is made exchangeable between a normal mode and a special mode allowing command information to be descrambled by using a special command, for example, a generally-called vender unique command freely defined by a vender (a machine dealer). Detail is as follows.

A vender unique (vender defining) command code region is set so as to range over command codes from C0h to FFh, for example, in an optical disc, and a command in the vender unique command code region is defined as that for exchanging a mode from the normal mode to the command scramble mode. For example, “C0h” is set as the command code for mode exchange. Accordingly, in this case, the information processing device (CD-ROM drive 1) of the present invention interprets a received command as a non-scrambled command information normally, namely, receives it as the “TUR” or “INQUIRY” command correctly until the command code “D0h” is received. When the mode exchange command “C0h” is issued according to a specific application program or the like after correct booting of the OS, the information processing device (CD-ROM drive 1) of the present invention descrambles the “TUR” or “INQUIRY” command scrambled in the host computer to interpret it correctly as the “TUR” or “INQUIRY” command, thereby ensuring correct operations of the CD-ROM drive 1 and the host computer.

The command “C0h” may have ON/OFF defined parameters of “00h,” a scramble mode OFF parameter and “01h,” a scramble mode ON parameter. Rather than the use of the parameters, “C1h” may be defined as a scramble release command.

Accordingly, in the present embodiment, in the case where the information processing device of the present invention which decodes command information and an ordinary information processing device incapable of decoding command information are connected to a host computer, descrambling of command information is set effective after the information processing device of the present invention receives a special command, such as the mode exchange command. As a result, even under the state where the confidentiality protected by encryption of command information, such as a boot sequence may invite an error of the information processing device of the present invention or malfunction of the host computer, the error and the malfunction can be prevented from being caused.

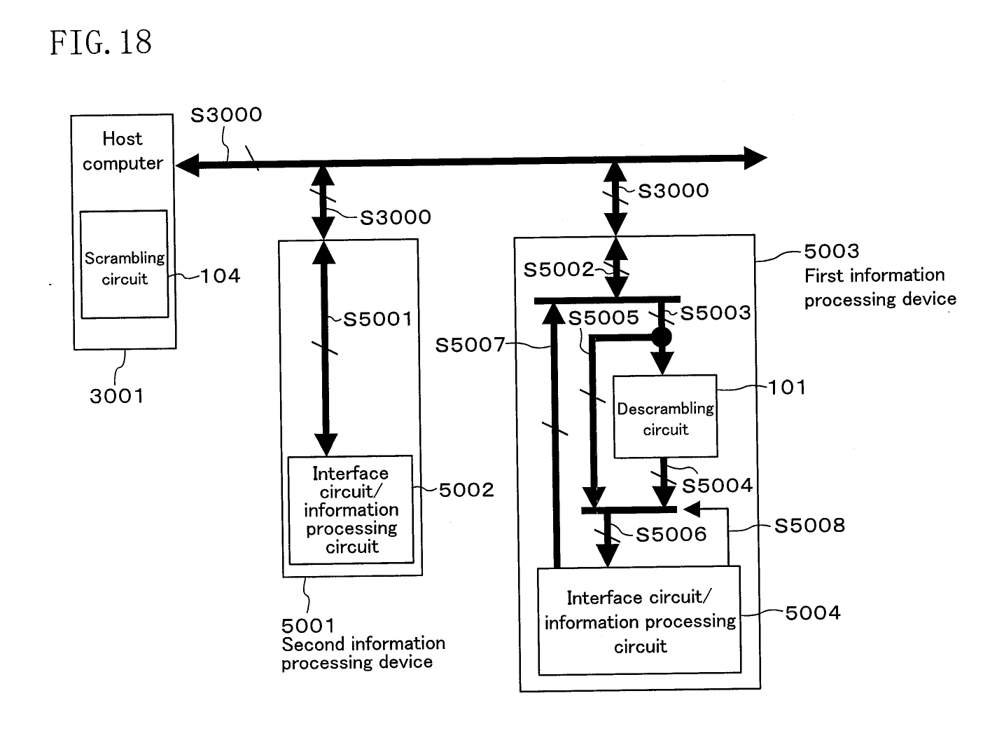

An embodiment of the above technique will be described next with reference to FIG. 18. In FIG. 18, reference numeral 3001 denotes a host computer in which a scrambling circuit 104 is built, 5003 denotes a first information processing device (CD-ROM drive 1) in which a descrambling circuit 101 decoding command information and an interface circuit/information processing circuit 5004 are built, and 5001 denotes an ordinary second information processing device (CD-ROM drive 2) in which only an interface circuit/information processing circuit 5002 is built with no descrambling circuit provided. Further, reference numeral S3000 denotes an interface signal, S5001 and S5002 each denote an interface internal signal, S5003 and S5005 denote write data and command signals, S5004 denotes a post descramble write data and command signal, S5006 denotes a write data and command signal, and S5007 denotes a read data and command signal.

In the information processing system shown in FIG. 18, the first information processing device 5003 not yet receiving the mode exchange command from the host computer 3001 takes to the inside thereof non-encrypted normal command information not via the descrambling circuit 101. When the host computer 3001 sends the mode exchange command and the first information processing device 5003 receives it, the host computer 3001 sends command information encrypted by the scrambling circuit 104 to the first information processing device 5003 and the interface circuit/information processing circuit 5004 built in the first information processing device 5003 outputs a selection signal S5008 to a selector or the like for executing mode exchange so that the command information decoded by the descrambling circuit 101 is selected to be taken inside as a write signal.

The above arrangement enables provision of a device and an interface circuit which allow communication with an ordinary device used in a field in which an increase in confidentiality is unnecessary with no problem involved as ever and which are usable in communication in application fields in which confidentiality is required to be increased.

The interface circuit/information processing circuit 5004 is not limited to a dedicated circuit but may include general-purpose programmable information processing means as a component, such as a microcomputer. Rather, a microcomputer or the like provided for the mode exchange is preferable in view of reduction in circuit scale.

### Embodiment 2

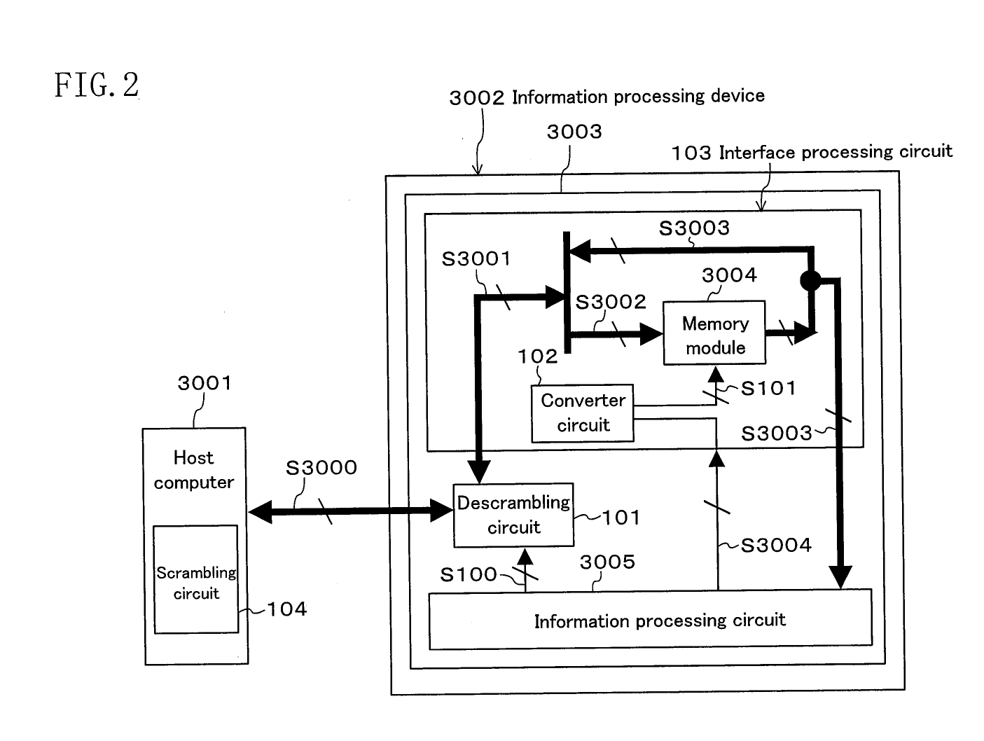

Embodiment 2 of the present invention will be described below with reference to the drawings. FIG. 2 is a block diagram showing one example of an information processing device and an information processing system in accordance with Embodiment 2 of the present invention. In FIG. 2, a converter circuit 102 (conversion means) and a post conversion memory control signal S101 are added to FIG. 1.

The conventional interface circuit, the conventional information processing device, and those described in Embodiment 1 involve a risk. Namely, when non-scrambled or descrambled transmitted data information and command information, such as a command packet is stored directly in a memory of the interface circuit, the memory of the interface circuit may be probed from outside with a result that the content of the information is analyzed.

Embodiment 2 of the present invention is made for solving this problem. In storing transmitted command information into a memory module (storage means) 3004, all or a part of storage addresses of information to be stored is randomized by the converter circuit 102, rather than generation of serial, namely, sequential storage addresses for storage.

Even if the content of data in the memory module 3004 is probed from outside to allow data stored there to leak, randomization of all or a part of the storage addresses inhibits anyone from readily knowing the content of the original data.

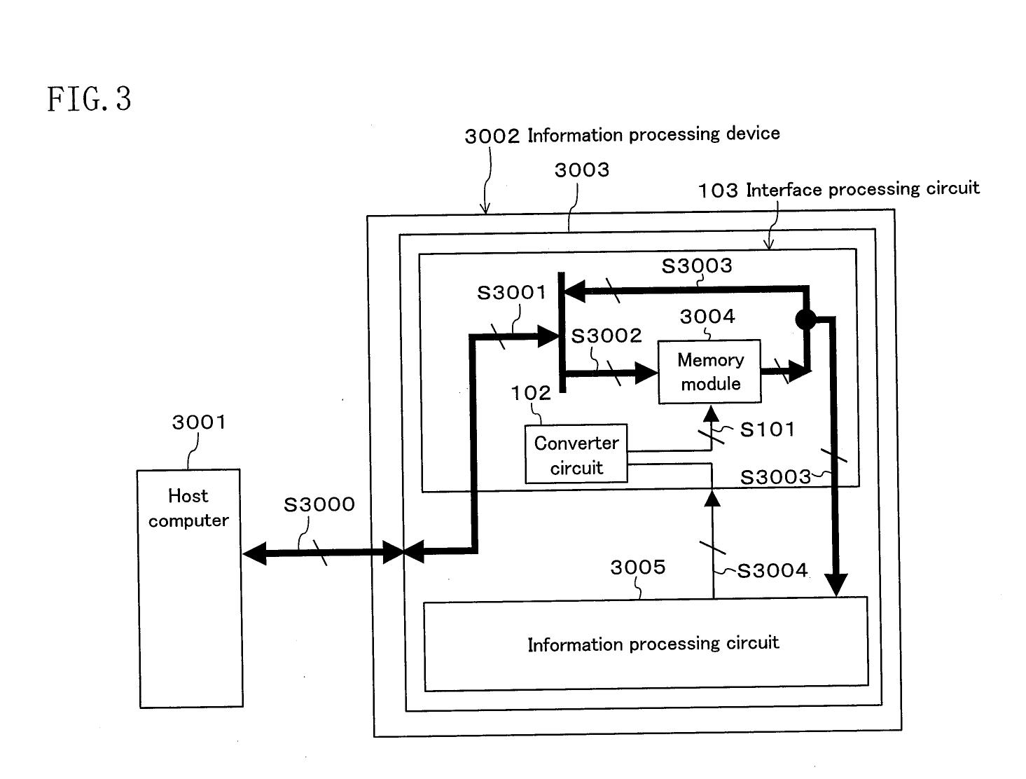

A second example according to Embodiment 2 of the present invention will be referred to next. FIG. 3 is a block diagram showing another example of an information processing device and an information processing system according to Embodiment 2 of the present invention. FIG. 3 shows a configuration of FIG. 2 from which the descrambling circuit (descrambling means) 101 and the descrambling circuit control signal S100 are removed. In the interface circuit and the information processing device having the block configurations shown in FIG. 3, even an interface circuit used for an information processing device that handles command information or data transmission, both of which are unnecessary to be descrambled, can directly utilize the circuit resource common to the interface circuit used for an information processing device that handles information which is necessary to be descrambled, which is worth using. In view of improvement on the circuit developing efficiency and the reliability by utilizing the same circuit, in other words, in view of promotion of making an interface circuit to be incorporated in an IP core, the interface circuit is desirable to have the configuration shown in FIG. 3 in advance.

As described above, the interface circuit according to Embodiment 2 of the present invention improves the circuit developing efficiency and the reliability.

It is noted that information stored in the memory module 3004 is not limited to command information but may be transmitted data information.

As one embodiment of the interface circuit according to the present invention, a specific operation of the interface processing circuit 103, especially, of the converter circuit 102 will be described in detail below.

### Embodiment 3

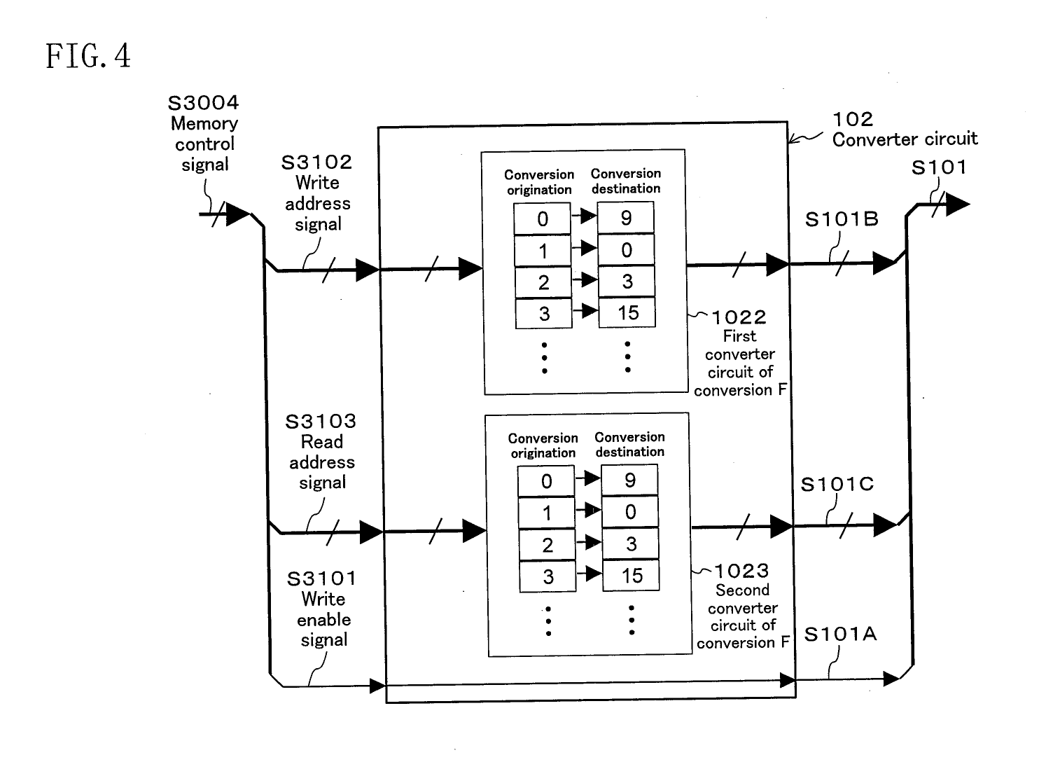

Embodiment 3 of the present invention will be described with reference to the drawings. FIG. 4 is a block diagram showing one example of a converter circuit 102 in an interface circuit in accordance with Embodiment 3 of the present invention.

In FIG. 4, reference numeral 102 denotes the converter circuit, 1022 denotes a first converter circuit of conversion F, 1023 denotes a second converter circuit of conversion F, S3101 denotes a write enable signal, S3102 denotes a memory write address signal, S3103 denotes a memory read address signal, S3004 denotes a memory control signal, S101 denotes a post conversion F memory control signal, S101A denotes a post conversion F write enable signal, S101B denotes a post conversion F memory write address signal, and S101C denotes a post conversion F memory read address signal.

With reference to FIG. 4, description will be given of a specific operation of the converter circuit 102 in the interface circuit in accordance with Embodiment 3 of the present invention. Upon reception of the memory write address signal S3102, the converter circuit 102 performs conversion F which makes a sequential sequence to be a random sequence in the first converter circuit 1022 and outputs the result as the signal S101B. Likewise, the converter circuit 102 performs, upon reception of the memory read address signal S3103, the conversion F which makes a sequential sequence to be a random sequence in the second converter circuit 1023 and outputs the result as the signal S101C. Further, the converter circuit 102 inputs the write enable signal S3101 and outputs it directly as the post conversion F write enable signal S101A without processing it. As can be understood from FIG. 4 and the description of the reference numerals, the first and second converter circuits 1022, 1023 should be circuits from which the same outputs are obtained from the same inputs, and therefore, they can be considered as the circuits having the same circuit configuration.

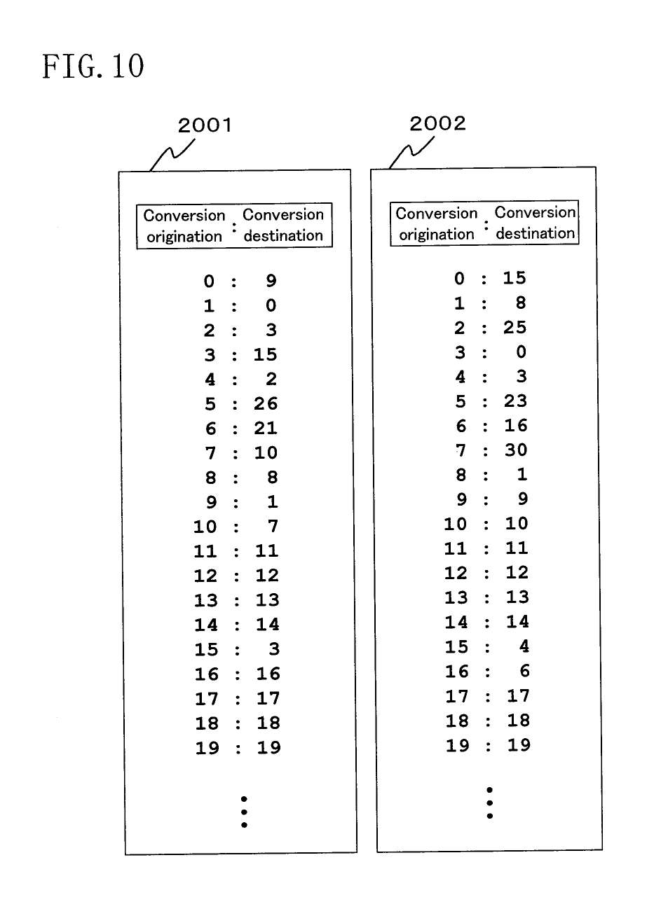

As indicated in the blocks of the first and second converter circuits 1022, 1023 in FIG. 4, the conversion F is a conversion which converts, for example, an input signal 0 to an output signal 9, an input signal 1 to an output signal 0, an input signal 2 to an output signal 3, an input signal 3 to an output signal 15, and so on. Further details are listed in a conversion table for conversion F(0) denoted by reference numeral 2001 in FIG. 10. Though the reference numeral 2001 in FIG. 10 denotes the conversion table for conversion F(0) as referred to in the index of reference numerals, the conversion F(0) means a conversion defined as a base conversion of arbitrary bit replacement patterns in the conversion F, which will be described later. The conversion F(0) herein is identical with the conversion F. According to the conversion table 2001, a sequential address sequence of “0→1→2→3→4→5→6→7→ . . . ” is converted to a non-sequential address sequence of “9→0→3→15→2→26→21→10→ . . . . ”

It is needless to say that the conversion table 2001 is not the sole conversion table for making a non-sequential sequence, namely, not the sole conversion table describing a conversion rule, and this conversion table shows one example of a preferable embodiment for reducing the present invention into practice. Conditions that are desirable to be satisfied as a conversion rule applied to the present invention will be described below.

For exemplifying a conditional expression desirable to be satisfied, it is assumed that a conversion origination 0 is converted to a value indicated by F(0)[0], a conversion origination 1 is converted to a value indicated by F(0)[1], and so on, and then, a conversion origination n is converted to a value indicated by F(0)[n] (the expression of F(m)[n] expresses one numeral value determined by the values m and n; herein the case where m=0 is described first).

(Conditional Expression 1)

Where j is an arbitrary integer satisfying 0≦j<k,

F(0)[j+1]≠F(0)[j]+1; and

F(0)[j+1]≠F(0)[j]−1

are satisfied.

Conditional Expression 1 is an expression requiring that the addresses after conversion (storage addresses to memory module) are non-sequential. A set of serial numeral values (incremented or decremented by one; for example, {3 and 4} or the like) before conversion is guaranteed not to be serial after conversion (not stored in adjacent storage cells in the memory module). The conversion F of which part is indicated in the blocks of the first and second converter circuits 1022, 1023 in FIG. 4, in other words, the conversion F(0) indicated in rather detail in the conversion table 2001 in FIG. 10 satisfies Conditional Expression 1 where 0≦j<8 (herein, the conversion F is identical with the conversion F(0), and accordingly, F(0) can be represented in the description). The conversions where j=0, 1, and 2 are as follows as examples.

F(0)[1]≠F(0)[0]+1=9+1=10

F(0)[1]=0≠F(0)[0]−1=9−1=8

F(0)[2]+1≠F(0)[1]+1=0+1=1

F(0)[2]=3≠F(0)[1]−1=0−1=−1

F(0)[3]+15≠F(0)[2]+1=3+1=4

F(0)[3]=15≠F(0)[2]−1=3−1=2

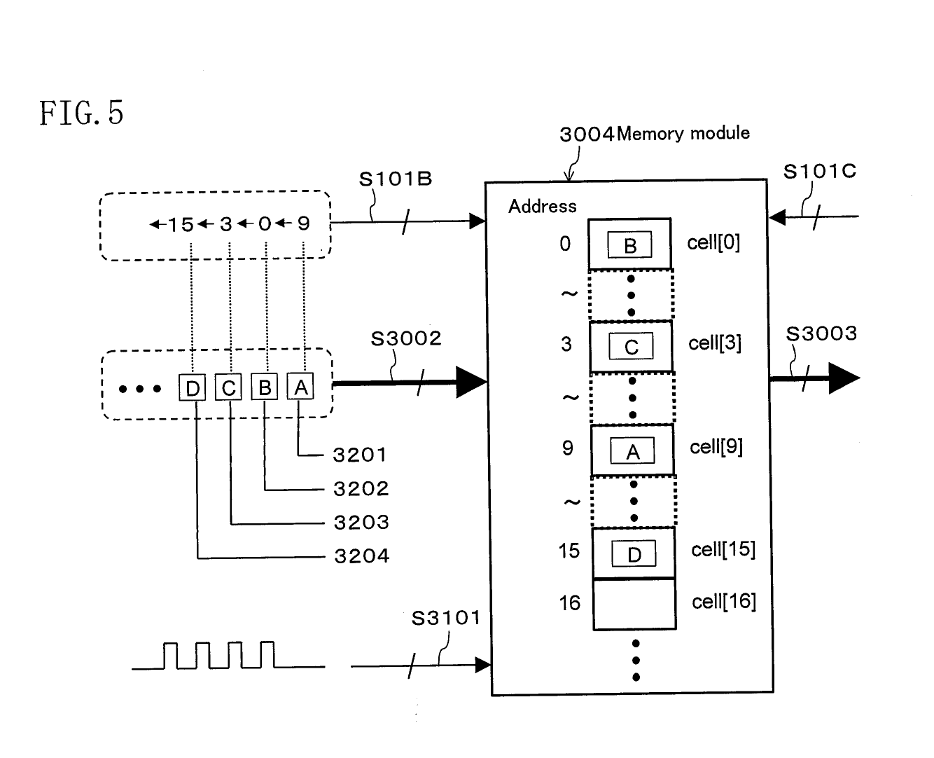

With reference to FIG. 5, description will be given next of effects by making a non-sequential sequence by the conversion F(0). FIG. 5 is a diagram showing one example of a writ operation to the memory in the interface circuit in Embodiment 3 of the present invention. In FIG. 5, reference numeral 3004 denotes a memory module, 3201 denotes first received data, 3202 denotes second received data, 3203 denotes third received data, 3204 denotes fourth received data, S101B denotes a post conversion F memory write address signal, S101C denotes a post conversion F memory read address signal, S3002 denotes a memory write data signal, S3003 denotes a memory read data signal, and S3101 denotes a write enable signal. From FIG. 4, it is understood that the conversion origination of the post conversion F memory write address signal S101B is the memory write address signal S3102. In writing the values on the memory write data signal S3002 into the memory module 3004 sequentially at the timing of the write enable signal S3101 while incrementing the memory write address signal S3102 to 0→1→2→3 in this order, the values of the address signal on the post conversion F memory write address signal S101B are converted like 9→0→3→15 by the conversion F. Accordingly, successive storage is performed in such a way that the first received data 3201 is stored at the address 9 of the memory module 3004, the second received data 3202 is stored at the address 0 thereof, the third received data 3203 is stored at the address 3 thereof, and the fourth received data 3204 is stored at the address 15 thereof. FIG. 5 shows that the received data 3201 to 3204 are stored into nonadjacent storage cells of the memory module 3004. Storage of serial received data into nonadjacent storage cells contributes to an increase in difficulty in intercept of received contents.

The conversion F has been described so far, and conversion F(i) will be described next (wherein i is an integer). The conversion F(i) is a conversion having a conversion table formed by substituting composition bits of each conversion destination in the conversion table for the base conversion F(0) under a uniform rule. Specifically, the uniform rule is “to replace a bit 0 by a bit 1,” “to replace a bit 1 by a bit 2,” “to replace a bit 0 by a bit 2,” and the like. More specifically, when it is suppose that each conversion destination in the conversion table for the conversion F(0) is composed of, for example, 5 bits and the bit of each conversion origination are expressed by {P4, P3, P2, P1, P0}, the uniform rule means that the conversion destination after rule application is bit-replaced to be, for example, {P4, P3, P2, P0, P1}, {P4, P3, P1, P2, P0}, {P4, P3, P0, P1, P2}, or the like in the previously listed three examples. Not only the aforementioned two-bit replacement, all the bits may be replaced like {P0, P1, P2, P3, P4} or the like. There are 120 (5!=5×4×3×2×1=120) kinds of such replacement, including the conversion origination, {P4, P3, P2, P1, P0}, where each conversion destination is composed of five bits. In conversion for obtaining numeral values as conversion destinations by bit-replacing the values of conversion originations in the conversion F(0), patterns other than the base conversion F(0) out of the available 120 conversion patterns are defined as conversion F(1) to conversion F(119).

In addition, it is desirable to define the bit-replaced conversion destinations not to be adjacent to each other as in the aforementioned Conditional Expression 1. Because:

assignment of each bit of an address value of an address signal supplied to the memory module 3004 to a bit line of an address (bus) signal is not necessarily determined from external observation; and accordingly, upon intercept of the content of received information by using bit line assignment other than the assumed assignment (conversion (F(0), for example), the conversion destinations may be adjacent to each other accidentally, which invites facilitation of analysis of the received content.

For this reason, the following conditional expression 2 is defined as a further desirable condition. As has been already described, the conversion F(i) in Conditional Expression 2 expresses a conversion having a conversion table formed by replacement of component bits of each conversion origination in the conversion table for the base conversion F(0) under a uniform rule. In the case where each conversion destination is expressed with a numeral value of five bits, L in Conditional Expression 2 is 120 (=5!).

(Conditional Expression 2)

Where an arbitrary integer pair of {i, j} satisfies 0≦i<1 and 0≦j<k,

F(i)[j+1]≠F(i)[j]+1; and

F(i)[j+1]≠F(i)[j]−1

are satisfied.

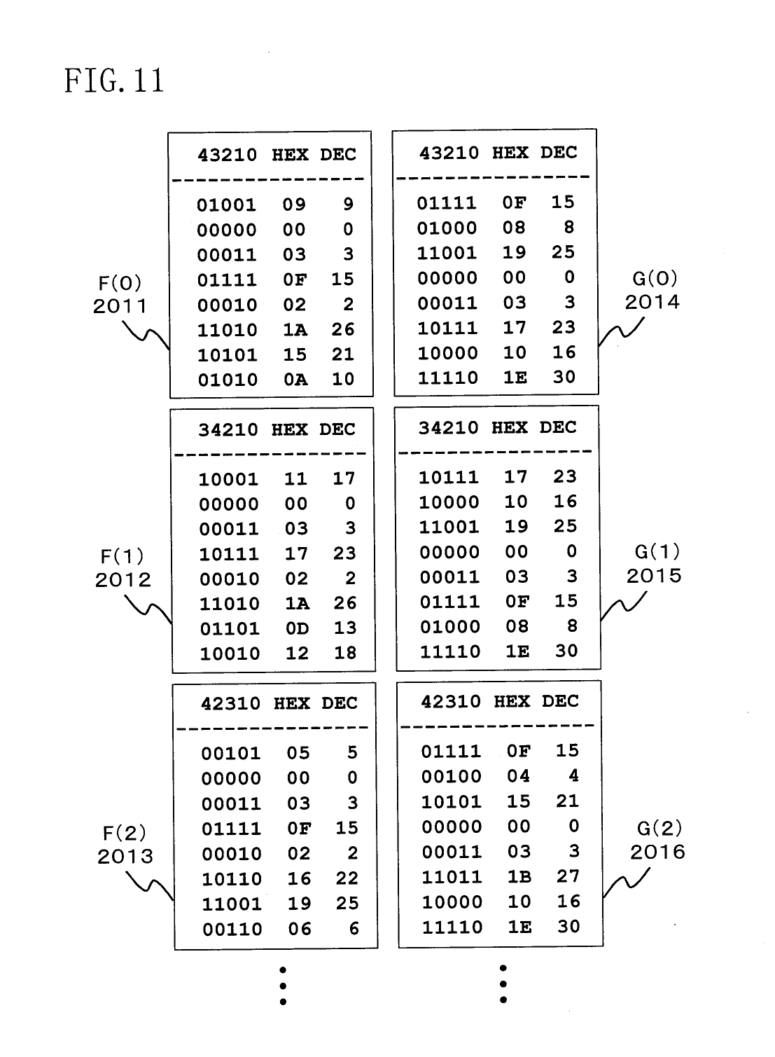

In FIG. 10, F(1) to F(119) in which the conversion destinations in the conversion F(0) denoted by reference numeral 2001 are bit-replaced satisfy the above Conditional Expression 2 where 0≦j<8. Specific examples are indicated as reference numerals 2011 to 2013 in FIG. 11. In FIG. 11, reference numeral 2011 denotes a list of conversion destinations corresponding to conversion originations 0 to 7 in the conversion F(0), 2012 denotes a list of conversion destinations corresponding to conversion originations 0 to 7 in conversion F(1), and 2013 denotes a list of conversion destinations corresponding to conversion originations 0 to 7 in conversion F(2). Reference numeral 2011 indicates a part of the conversion destinations in the conversion F(0), wherein “43210” in the first line expresses each bit position, “bit 4,” “bit 3,” . . . , and “bit 0,” and the adjacent “HEX” and the subsequent “DEC” express hexadecimal notation and decimal notation thereof, respectively. The second line is a mere line separating the description in the first line and the data in the third and subsequent lines. The third line first lists “01001” in binary notation, which is “9” in decimal notation. The bit 4 and the bit 3 are listed in the column indicating “4” and the column indicating “3,” respectively, in the first line. Similarly, the bit 0 is listed in the column indicating “0” in the first line, and so on. The element listed next in the third line is “09,” which is expression by hexadecimal notation of “9” in decimal notation. The last element in the third line is “9,” which is “9” itself in decimal notation. In this way, the elements in the third line express 9 in binary notation, hexadecimal notation, and decimal notation. “9” in the third line is a conversion destination when the conversion F(0) is applied to the conversion origination “0.” The subsequent conversion destinations “0” . . . “10” are listed correspondingly to the conversion originations “1” . . . “7”. Reference numeral 2012 lists conversions in which the bit 4 and the bit 3 of the conversion originations are replaced in conversion F(0). Herein, this conversion is called conversion F(1). Conversion by the conversion F(1) is expressed as a list denoted by reference numeral 2012. Similarly, conversion in which the bit 3 and the bit 2 of the conversion originations are replaced in conversion F(0) is conversion F(2) denoted by reference numeral 2013. Though not referred to in detail, it is understood that the same calculation as described above proves that the conversion destinations in the reference numerals 2012 and 2013 satisfy Conditional Expression 2. The calculation reveals that the conversion F(0) is so designed to satisfy Conditional Expression 2 in all the conversion F(i) where 0≦i≦120.

It is practically possible to find a conversion that satisfies Conditional Expression 2 as a conditional expression for all the derived conversions F(1) to F(119), in addition to the basic conversion F(0), in which conversion destinations are bit-replaced. Wherein, whether it can be found or not depends on combination of the number of bits of each conversion destination and the value of K in the conditional expression. In the case where the number of bits of the conversion destinations is small while the value of K is large, no conversion satisfying Conditional Expression 2 may be found. In the case where the number of bits of each conversion destination is five while K is eight in any case, as indicated in the present embodiment, the conversion F (F(0) to F(119)) are found as one of conversions satisfying Conditional Expression 2.

### Embodiment 4

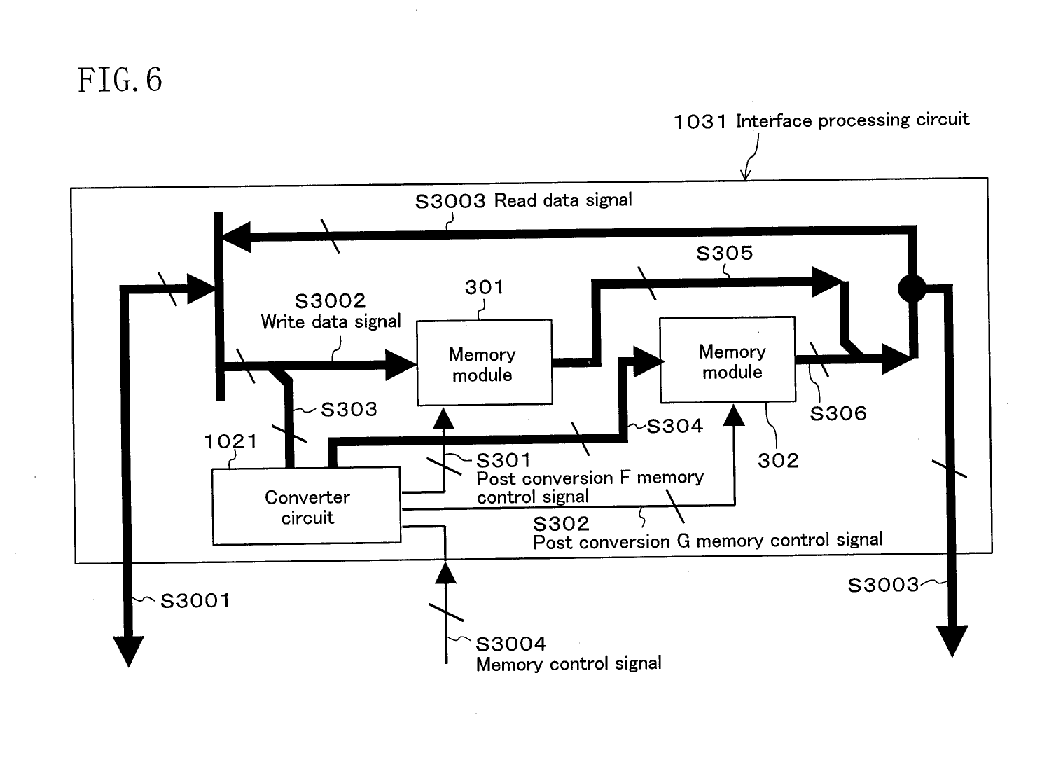

A specific operation of an interface circuit in accordance with Embodiment 4 of the present invention will be described below with reference to FIG. 6 to FIG. 14.

First referred to is FIG. 6 as a block diagram showing one example of an interface circuit of Embodiment 4. In FIG. 6, reference numeral 1021 denotes a converter circuit, and 1031 denotes an interface processing circuit. Further, reference numerals 301 and 302 denote memory modules functioning as two sub storage means composing one storage means. In addition, S3001 denotes an interface internal signal, S3002 denotes a memory writhe data signal, S3003 denotes a memory read data signal, S3004 denotes a memory control signal, S301 denotes a post conversion F memory control signal, S302 denotes a post conversion G memory control signal, S303 denotes a pre N-clock delay memory write data signal (N is an integer larger than one), S304 denotes a post N-clock delay memory write data signal, and S305 and S306 each denote a memory read data signal.

The difference of the interface circuit in Embodiment 4 from the interface circuit in Embodiment 3 lines in that the memory module 30004 is divided into the two memory modules 301, 302. The two memory modules (sub storage means) 301, 302 include storage cells for respectively storing upper data and lower data (divided information) into which data in access unit is divided, wherein data in the access unit can be stored in a single storage cell of the memory module 3004. In a case of, for example, an ATAPI interface, which performs communication through a data bus of a 16-bit width, the date in the access unit (namely, data of one word stored in one storage cell) for the memory module 3004 is assumed to have 16 bits. In a case of such an ATAPI interface, the data in the access unit (data of one word stored per one address) is composed of each eight bits in each of the upper and lower bits for the memory modules 301, 302 of the interface circuit of Embodiment 4. The case of the ATAPI interface will be described below as one example.

The memory module 301 is a memory module for storing upper eight bits of each word (16 bits) composing a command packet. In addition, it may have a configuration capable of storing upper eight bits of transmission data in data transmission phase. The memory module 302 is a memory module for storing lower eight bits of each word (16 bits) composing a command packet. Further, it may have a configuration capable of storing transmission data, as well. The converter circuit 1021 generates the signal S301 and the signal S302 as memory control signals and provides them to the memory modules 301, 302, respectively.

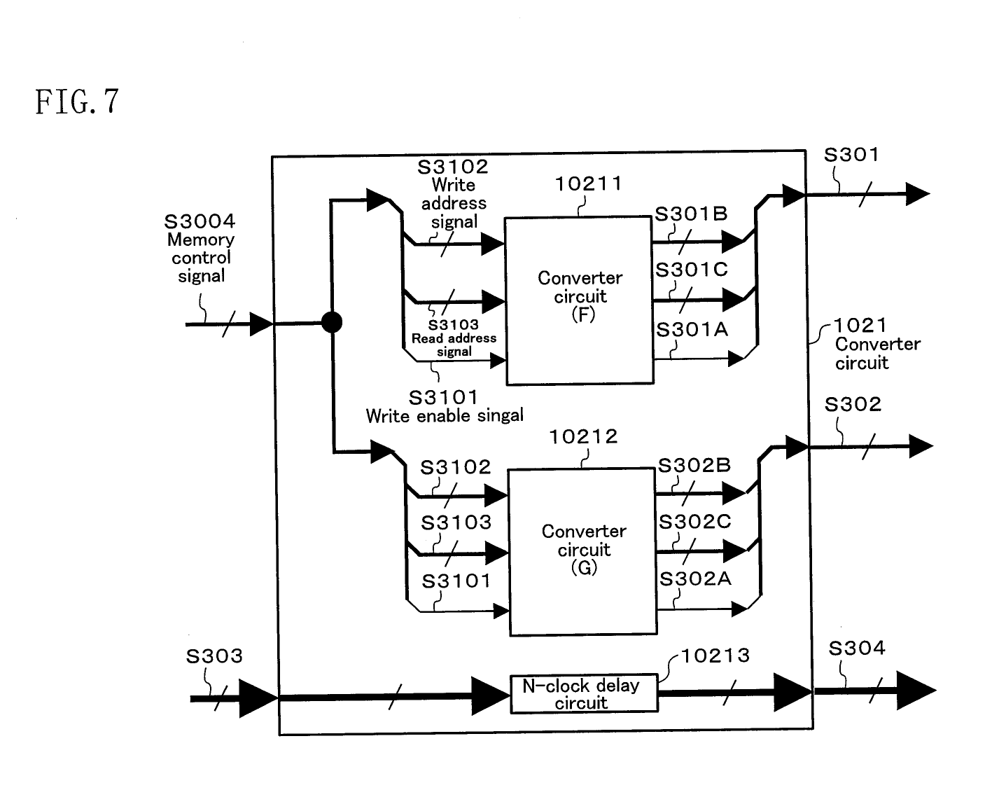

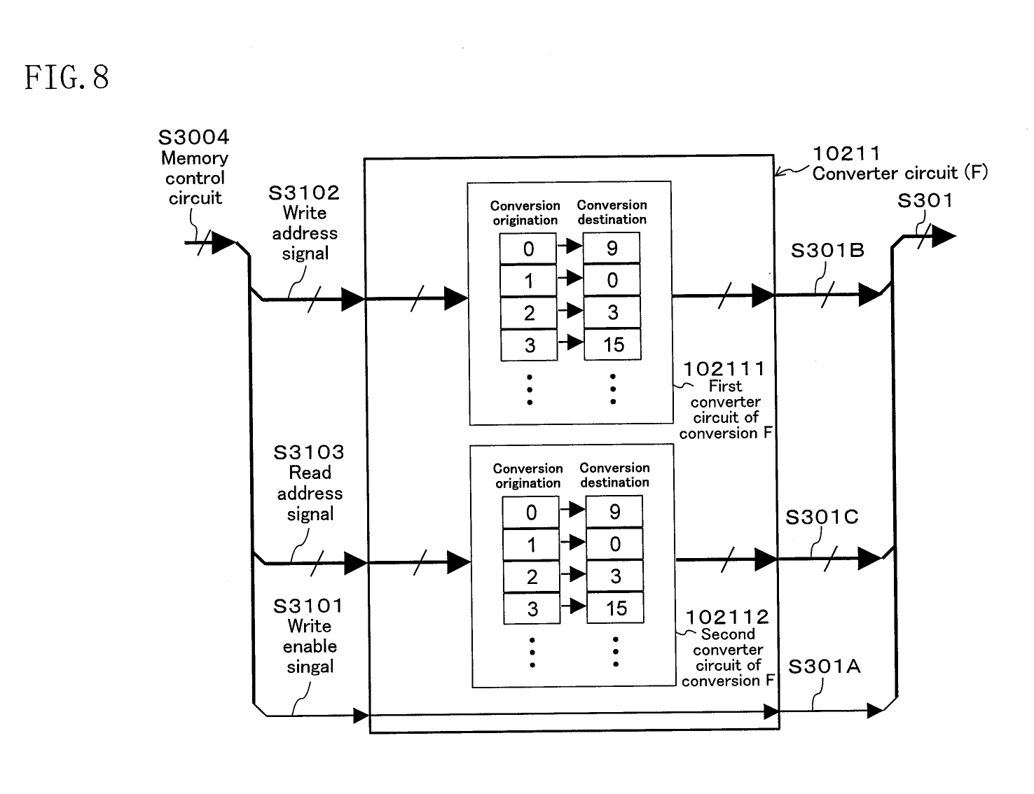

Next, one example of a configuration of the converter circuit 1021 will be described with reference to FIG. 7. In FIG. 7, reference numeral 10211 denotes a converter circuit (F), 20212 denotes a converter circuit (G), 10213 denotes a data signal N-clock delay circuit (delay means) delaying the data signal by N clock (N is an integer satisfying 1≦N), S3004 denotes a memory control signal, S3101 denotes a write enable signal, S3102 denotes a memory write address signal, S3103 denotes a memory read address signal, S301 denotes a post conversion F memory control signal, S301A denotes a post conversion F write enable signal, S301B denotes a post conversion F memory write address signal, S301C denotes a post conversion F memory read address signal, S302 denotes a post conversion G memory control signal, S302A denotes an N-clock delay write enable signal, S302B denotes a post conversion G memory write address signal, S302C denotes a post conversion G memory read address signal, S303 denotes a pre N-clock delay memory write data signal, and S304 denotes a post N-clock delay memory write data signal. The converter circuit (F) 10211 corresponds to the converter circuit 102 described in Embodiment 3, and an identical one in circuit may be used as the converter circuit (F) 10211. FIG. 8 shows one example of a configuration of the converter circuit 10211, which is the same configuration as that of the converter circuit 102 in FIG. 4. In FIG. 8, reference numeral 10211 denotes the converter circuit (F), 102111 and 102112 denote first converter circuit (Fa) and a second converter circuit (Fb) included in the converter circuit (F), respectively, S3101 denotes a write enable signal, S3102 denotes a memory write address signal, S3103 denotes a memory read address signal, S3004 denotes a memory control signal, S301 denotes a post conversion F memory control signal, S301A denotes a post conversion F write enable signal, S301B denotes a post conversion F memory write address signal, and S301C denotes a post conversion F memory read address signal.

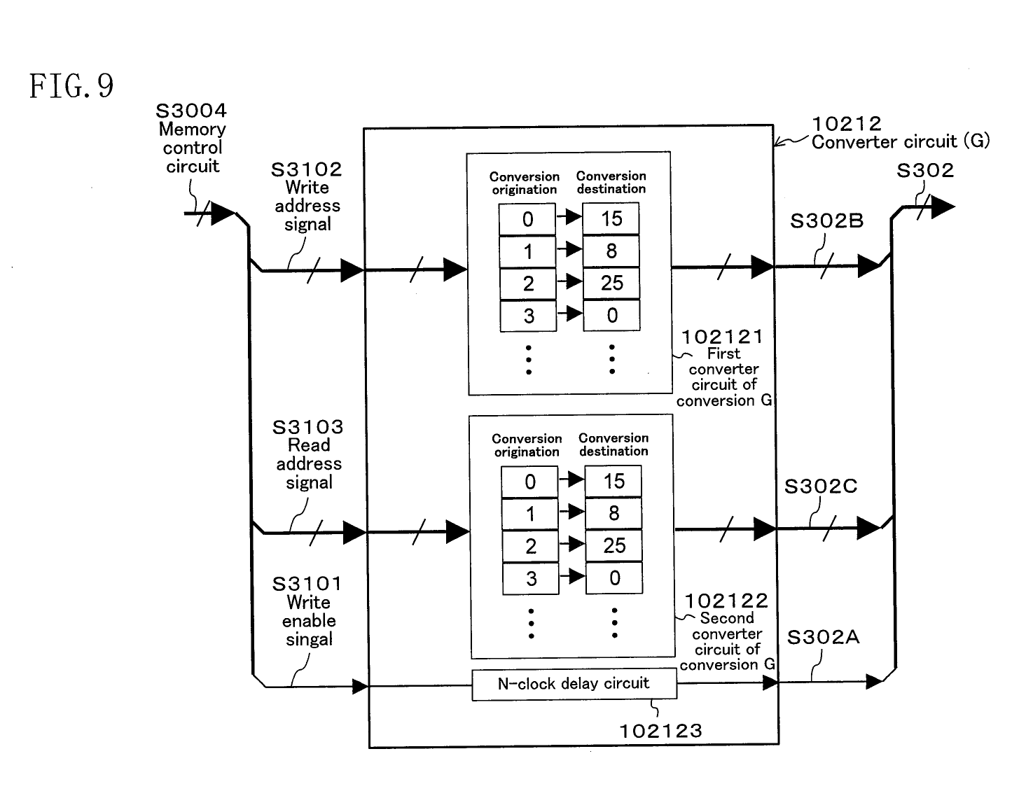

The converter circuit (G) denoted by 10212 is a converter circuit having a conversion table different from the conversion table in the converter circuit 10211. FIG. 9 shows on example of a configuration of the converter circuit 10212. In FIG. 9, reference numeral 10212 denotes the converter circuit (G), 102121 and 102122 are converter circuits of conversion G, 102123 denotes a write enable signal N-clock delay circuit, S3101 denotes a write enable signal, S3102 denotes a memory write address signal, S3103 denotes a memory read address signal, S3004 denotes a memory control signal, S302 denotes a post conversion G memory control signal, S302A denotes an N-clock delay write enable signal, S302B denotes a post conversion G memory write address signal, and S302C denotes a post conversion G memory read adders signal. Each of the converter circuits 102121, 102122 in the converter circuit 10212 performs conversion of the signal value in accordance with the conversion table 2002 for conversion G(0) indicated in FIG. 10. Similarly to the conversion table 2001 for the conversion F(0), the conversion table 2002 satisfies the same condition as Conditional Expression 2 indicated in Embodiment 3. Namely, the following Conditional Expression 3 is satisfied. Though the method for checking whether the condition is satisfied is not described herein because it is the same as that for the conversion F described in Embodiment 3, reference numerals 2014 to 2016 in FIG. 11 indicate variations in bit replacement of the conversion destinations in conversion G(0). In FIG. 11, reference numeral 2014 denotes a list of conversion destinations corresponding to conversion originations 0 to 7 in conversion G(0), 2015 denotes a list of conversion destinations corresponding to conversion originations 0 to 7 in conversion G(1), and 2016 denotes a list of conversion destinations corresponding to conversion originations 0 to 7 in conversion G(2).

(Conditional Expression 3)

Where an arbitrary integer pair {i, j} satisfies 0≦1<L and 0≦j<K,

G(i)[j+1]≠G(i)[j]+1; and

G(i)[j+1]≠G(i)[j]−1

are satisfied.

Referring to the relationship between the conversion F(0) indicated in the conversion table 2001 and the conversion G(0) indicated in the conversion table 2002, they can be designed so as to be associated with each other for satisfying a further desirable condition in addition to the condition that the addresses of conversion destinations are not adjacent to each other when the addresses of two conversion originations which are adjacent to each other are converted.

In the present embodiment, the conversion F and the conversion G are defined on the basis of such a further desirable design. Specifically, the following Conditional Expression 4 is satisfied. In specific conversion described in the present embodiment, K=8 and L=120 are set likewise the description in Embodiment 3.

(Conditional Expression 4)

Where an arbitrary integer set of {h, i, j} satisfies 0≦h<L, 0≦i≦L, and 0≦j<K,

F(h)[j]≠G(i)[j]

is satisfied.

Conditional Expression 4 means as follows: in the case where the address of upper 8-bit data of 16-bit data per one word is converted according to the conversion F while lower 8-bit data thereof is converted according to the conversion G in an ATAPI or the like and the thus converted data are stored into separate memory modules, the data of the first K (=8) words have different address values after conversion as the conversion F and the conversion G irrespective of which bit line of address (bus) signal each bit of an address value after the conversion F or the conversion G is assigned. Namely, in the case of an ATAPI, data of six words or eight words composing an ATAPI command packet involves no risk that the address values after conversion according to the conversion F and the conversion G are identified with those before the conversions, and accordingly, a situation is not caused in which hint for analysis that the lower eight bits and the upper eight bits are associated with each other and sequential is given.

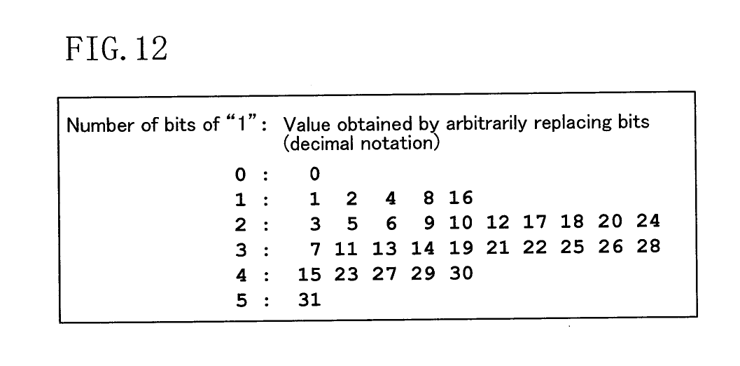

Whether or not the conversion F and the conversion G satisfy Conditional Expression 4 can be checked readily according to the table indicated in FIG. 12. FIG. 12 is a table grouping, according to the numbers of bits of “1,” values obtained by arbitrarily replacing bits of numeral values expressed with five bits. When focusing attention on the conversion destination list 2011 (conversion F(0)) and the conversion destination list 2014 (conversion G(0)) in FIG. 11, the conversion destinations (decimal notation) corresponding to the conversion origination “0” in the third line are “9” and “15,” respectively, and the numbers of bits of “1” of the five bits in binary notation are “2” and “4,” respectively (“9” in decimal notation is “01001” in binary notation which contains two bits of “1” while on the other hand “15” in decimal notation is “01111” in binary notation which contains four bits of “1”). Similarly, the conversion destinations corresponding to the conversion origination “1” in the fourth line have “1” of which number of bits are “0” and “1,” which are different from each other. As well, the conversion destinations corresponding to the respective conversion originations “2” to “7” in the respective fifth to tenth lines-have “1” of which numbers of bits are different from one another. As indicated in FIG. 12, there are plural cases that some numeral values have “1” of which number of bits are the same. Therefore, after bit replacement of the numeral values, the numeral values become any of the numeral values indicated in the same lines (the right side of “:”) in FIG. 12. In a case with the numeral values of which numbers of bits of “1” are different from each other, however, any bit replacement never results in the same numeral values. Accordingly, according to the conversion destination list 2011 (the conversion F(0)) and the conversion destination list 2014 (the conversion G(0)) in FIG. 11, the conversion destinations corresponding to the conversion originations “0” to “7” do not have numeral values (address values) containing “1” of which numbers of bits are the same. Hence, it can be said that even independent application of any bit replacement to the conversion F and the conversion G never results in that the conversion destinations after conversion F and the conversion G have the same numeral values (address values).

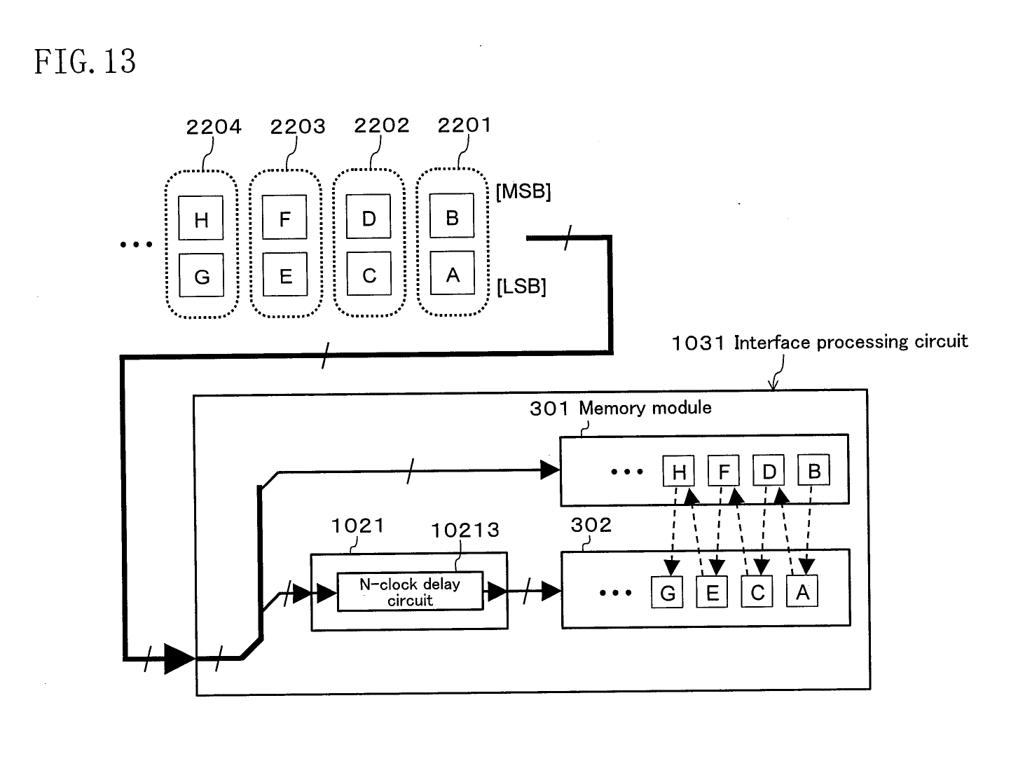

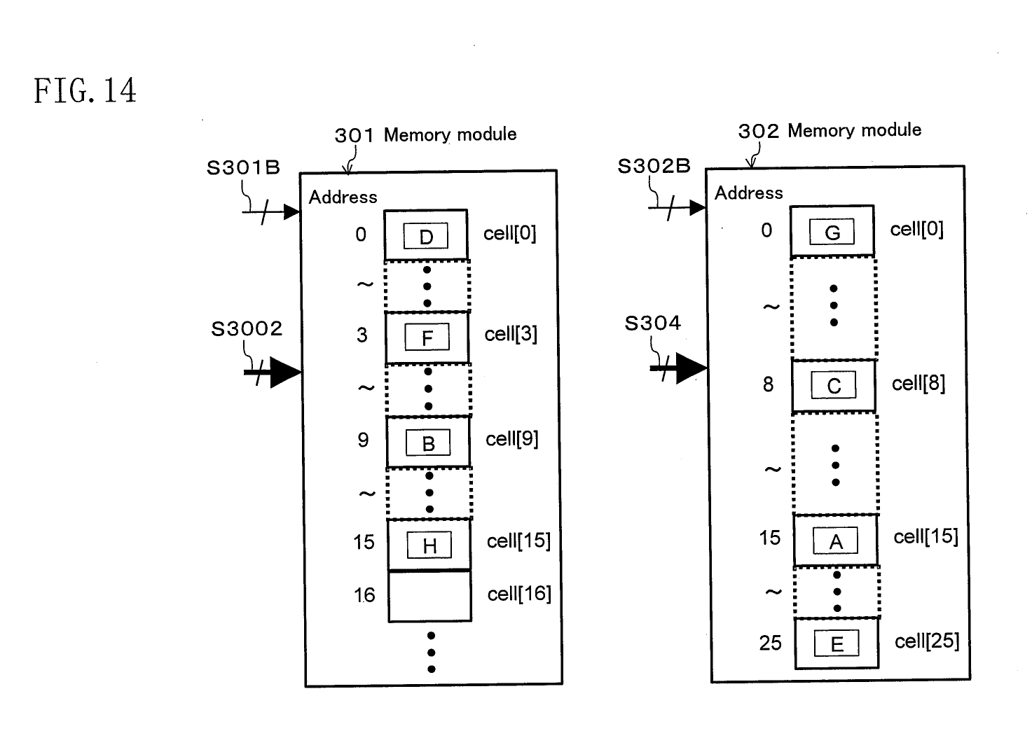

With reference to FIG. 13 and FIG. 14, further description will be given next of additional effects by making a non-sequential sequence according to the conversion F(0) and the conversion G(0). FIG. 13 is a diagram showing one example of a write operation to a memory in the interface circuit in Embodiment 4 of the present invention. In FIG. 13, reference numerals 301 and 302 each denote a memory module, 1021 denotes a converter circuit, 10213 denotes a data signal N-clock delay circuit, 1031 denotes an interface processing circuit, 2201 denotes first received data, 2202 denotes second received data, 2203 denotes third received data, and 2204 denotes fourth received data. As shown in FIG. 13, the received data 2201 to 2204 are input sequentially. In the case of an ATAPI command packet as will be specifically described here, each of the received data 2201 to 2204 is 16-bit data per one word. As shown in the drawing, the lower byte of the received data 2201 is represented by “A” while the upper byte thereof is represented by “B.” Similarly, the lower byte of the received data 2202 is represented by “C” while the upper byte thereof is represented by “D.” Subsequent data are as indicated in the drawing, as well. These data are interpret in a byte order (a sequence of bytes) of “A,” “B,” “C,” “D,” . . . as command information of the ATAPI (though two-ward or four-ward data reception are followed further in the ATAPI, the following data are processed in the same manner as that to the first four-ward data, and therefore, the description thereof is omitted). Upon reception of these ATAPI command packets, the upper byte “B” of the received data 2201 is stored first into the memory module 301 necessarily. Thereafter, the lower byte “A” of the received data 2201 is stored into the memory module 302 with N clock (N is an integer satisfying N≧1) delayed. Subsequently, the upper byte “D” of the received data 2202 is stored into the memory module 301, and then, the lower byte “C” thereof is stored into the memory module 302 with N clock delayed. Similarly, alternate storage of the following upper bytes into the memory module 301 for storing upper bytes and the lower bytes into the memory module 302 for storing lower bytes with each N clock delayed are performed. In this way, the storage sequence of the ATAPI command packet is “B”→“A”→“D”→“C”→“F”→“E” . . . .

Storage addresses in each memory module 301, 302 in this operation example will be described next with reference to FIG. 14. In FIG. 14, reference numerals 301 and 302 each denote a memory module, S301B denotes a post conversion F memory write address signal, S302B denotes a post conversion G memory write address signal, S3002 denotes a memory write data signal, and S304 denotes a post N-clock delay memory write data signal. The conversion F(0) and the conversion G(0) are defined, as has been described with reference to FIG. 8, FIG. 9, and FIG. 10, so that the conversion destination addresses corresponding to the destination origination address “0” of the received data 2201 are “9” and “15.” Accordingly, the write operation for each of the upper and lower bytes of the received data 2201 is performed separately by writing the upper byte data “B” of the received data 2201 at the address “9” in the memory module 301 and writing the lower byte data “A” of the received data 2201 at the address “15” in the memory module 302. As the writing sequence, “B” is written first, and “A” is then written with N clock delayed for the writing of “B.” Subsequently, as well, the upper byte and the lower byte of each word composing an ATAPI command packet are written at separate addresses in the separate memory modules at different timings (with time difference of N clock delayed by the N-clock delay circuit 1021), as shown in FIG. 14. Even if data in which the bit positions corresponding to the signal lines of the signal S301B and the signal S302B are replaced anyway is interpret, data of the upper and lower bytes belonging to the same word are stored at different addresses of the different memory modules. This provides no hint for information analysis to the utmost when the information storage portion in the interface circuit is proved from outside, thereby enabling command communication with increased safety.

The memory module is divided into two for storing upper bytes and lower bytes separately in Embodiment 4, but the number of divided memory modules is not limited to two. Division by three or more can realize an interface circuit with increased safety similarly to that described heretofore, and it is needless to say that the same effects as in the case where the memory module is divided into two or further effects can be obtained. In Embodiments 1 to 4 of the present invention, the ATAPI is exemplified specifically for describing the specific host interface, but the present invention is not limited to the ATAPI and any host interface, such as an SCSI or the like function just the same effectively, of course.

Referring to applicable fields of the information processing device described in Embodiments 1 to 4 of the present invention, specifically, it is applicable to at least information replaying devices and information recording/replaying devices, such as optical click devices, magnetic tape units, and memory card devices. These are some of typical application fields utilizing digital interfaces, such as an ATAPI interface, an SCSI interface, and the like.

### INDUSTRIAL APPLICABILITY

As described above, the interface circuit, the information processing device, and the information processing system according to the present invention are widely useful in communication purpose between digital appliances containing to-be-concealed information. Further, they are expected to be applied to interfaces especially in information replaying devices, information recording/replaying devices, and the like, for optical discs of DVDs and the like.

1. (canceled)

2. An interface circuit comprising:
storage means; and
conversion means which sequentially receives a plurality of successive serial information units, which compose command information or data information, and generates storage addresses to the storage means by address conversion which makes all or a part of the information units of at least one of the command information and the data information to be in a sequence at least other than a reception sequence,
wherein each of the information units of the command information or the data information as a target of the address conversion is written into the storage means at a corresponding storage address address-converted by the conversion means, and
the conversion means performs the address conversion with the address conversion defined as conversion F for converting a sequential sequence to a random sequence, the conversion F satisfying both of:
F[j+1]≠F[j]+1; and
F[j+1]≠F[j]−1,
where the conversion F is a function for converting an address j (j is an arbitrary integer satisfying 0≦j≦K where K is an arbitrary integer larger than 1) of a conversion origination to an address F[j] of a conversion destination.

3. (canceled)

4. The interface circuit of claim 2, wherein
the conversion means generates the storage address so that even when address values generated by replacing two or more bits of each of storage addresses after the address conversion is regarded as second address values, all or a part of the information units of the command information or the data information as a target of the address conversion is in a sequence other than the reception sequence.

5. The interface circuit of claim 4, wherein
in obtaining different addresses F(i)[j] of different conversion destinations by repeating i times (i is an integer) replacement of predetermined two or more component bits of an address F[j] of a conversion destination after the conversion F under a predetermined rule, the conversion means performs the address conversion with the address conversion defined as the conversion F, the conversion F satisfying both of:
F(i)[j+1]≠F(i)[j]+1; and
F(i)[j+1]≠F(i)[j]−1,
where an arbitrary integer pair of {i, j} satisfies 0≦i≦L and 0≦j<K (i is an arbitrary integer satisfying 0≦i<K, and L is an arbitrary integer larger than 1).

6. (canceled)

7. An interface circuit comprising:
storage means; and
conversion means which sequentially receives a plurality of successive serial information units, which compose command information or data information, and generates a storage address to the storage means by address conversion which makes all or a part of each of the information units of at least one of the command information and the data information to be in a sequence at least other than a reception sequence,
wherein each of the information units of the command information or the data information as a target of the address conversion is written into the storage means at a corresponding storage address address-converted by the conversion means,
the storage means includes a plurality of sub storage means,
each information unit of the command information data or the data information as a target of the address conversion is divided and stored into the plurality of sub storage means separately and
in storing each of the plurality of divided information units into the plurality of sub storage means separately, the conversion means generates storage addresses different from each other for plural pieces of divided information of each of a part or all of the plurality of information units.

8. The interface circuit of claim 7, wherein
the conversion means performs the address conversion with the access conversion defined as the conversion F and conversion G for converting a sequential sequence to a random sequence, the conversion F and the conversion G satisfying both of:
F[j+1]≠F[j]+1; and
F[j+1]≠F[j]−1, and
both of:
G[j+1]≠G[j]+1; and
G[j+1]≠G[j]−1, respectively,
where the conversion F and the conversion G are functions for converting an address j (j is an arbitrary integer satisfying 0≦j<K where K is an arbitrary integer larger than 1) of an address origination to addresses F[j] and G[j] of conversion destinations, respectively, and the conversion F and the conversion G satisfying:
F(h)[j]≠G(i)[j]
where an arbitrary integer set of {h, i, j} satisfies 0≦h<L, 0≦i<L, and 0≦j<K (h is an arbitrary integer larger than 1).

9. The interface circuit of claim 7 or 8, further comprising:
delay means for delaying the plural pieces of divided information for a predetermined time period so that timings at which the plural pieces of divided information are stored into the plurality of sub storage means are different from each other in storing the plural pieces of divided information into the plurality of sub storage means.

10. The interface circuit of any one of claims 2, 4, 5, 7, and 8, wherein
each of the information units is data of one word composed of eight bits or 16 bits.

11. The interface circuit of any one of claims 2, 4, 5, 7, and 8, wherein
the command information or the data information is transmitted or received between a plurality of information processing devices through a transmission path intervening between the plurality of information processing devices.

12. The interface circuit of claim 11, wherein
the transmission path is an ATA/IDE bus or an SCSI bus.

13. An information processing device, comparing:
an interface circuit according to any one of claims 2, 4, 5, 7, and 8; and
an information processing circuit for controlling the interface circuit.

14. An information processing device comprising:
an interface circuit including:
storage means: and
conversion means which sequentially receives a plurality of successive serial information units, which compose command information or data information, and generates a storage address to the storage means by address conversion which makes all or a part of each of the information units of at least one of the command information and the data information to be in a sequence at least other than a reception sequence, each of the information units of the command information or the data information as a target of the address conversion being written into the storage means at a corresponding storage address address-converted by the conversion means and the command information or the data information to be address-converted being encrypted;
descrambling means for decoding the encrypted command information or data information before storage to the storage means; and
an information processing circuit for controlling the interface circuit, the information processing circuit allowing the descrambling means included in the interface circuit to decode the command information only upon reception of a vender unique command.

15. (canceled)

16. (canceled)

17. An information processing system comprising:
an information processing device according to claim 14; and
a second information processing device communicating with the information processing device,
wherein the second information processing device includes scrambling means for encrypting the command information to be transmitted.

18. The information processing system of claim 17, wherein
the second information processing device transmits a vender unique command to the information processing device according to claim 14 and transmits, after transmission of the vender unique command, the command information encrypted by the scrambling means to the information processing device according to claim 14.

19. The information processing system of claim 17 or 18, wherein
the second information processing device is a host computer.

20. The information processing system of claim 19, wherein the second information processing device is a host computer, and the scrambling means is a program executed on the host computer.
